(19) United States
(12) Patent Application Publication
(10) Pub. No.: US 2008/0153347 A1
(43) Pub. Date: Jun. 26, 2008

(54) Battery Connector

(75) Inventors: Ming-Chun Lai, Taipei Hsien (TW); Yu Li, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 11/613,271

(22) Filed: Dec. 20, 2006

(51) Int. Cl. H01R 3/00

(52) U.S. Cl. 439/500; 429/123

(57) ABSTRACT

A battery connector includes a housing having a terminal recess and a plurality of electric terminals. The terminal recess has an inlay recess in the bottom of the terminal recess and a receiving cavity extending from the top of the terminal recess to the inlay recess, and an opening is dug at the end of the inlay recess. The electric terminal comprises a base portion, a contacting portion and a soldering portion. The base portion is received in the inlay recess. The contacting portion extends out of the receiving cavity for connecting the battery. The soldering portion was exposed by the opening of the housing. The repairman can replenish solder to the soldering portion by the opening of the housing if the machine omits soldering the soldering portion of the battery connector during excessive production.

### BACKGROUND OF THE INVENTION

1. Field of the Invention

The present invention relates to a battery connector, and more particularly to a battery connector used in a portable electronic device for connecting with a battery received in the portable electronic device.

2. The Related Art

A battery connector used in a mobile phone or other portable apparatus conventionally comprises a housing and a plurality of electric terminals. A terminal recess is defined in the housing. The electric terminal comprises a soldering portion, a base portion and a contacting portion. The soldering portion and the base portion are received in the terminal recess except the contacting portion of the electric terminal.

However, the machine will omit soldering the soldering portion of the battery connector on the printed circuit board during excessive production. Because the soldering portion of the electric terminal is received in the housing, the repairman can not replenish with solder on the soldering portion, and then the whole battery connector and the printed circuit board needs to be replaced, as a result, it wastes time and resources and increases the cost of production.

### SUMMARY OF THE INVENTION

An object of the present invention is to provide a battery connector which comprises a housing having a terminal recess and a plurality of electric terminals. The terminal recess has an inlay recess defined in the bottom of the terminal recess and a receiving cavity extending from the top of the terminal recess to the inlay recess. An opening is dug at the end of the inlay recess. The electric terminal comprises a base portion, a contacting portion and a soldering portion. The base portion is fixed in the inlay recess. The contacting portion extends out of the receiving cavity for connecting the battery. The soldering portion is exposed by the opening of the housing.

Because of the present invention repairman can replenish solder to the soldering portion by the opening of the housing if the machine omits soldering the soldering portion of the battery connector during excessive production. By this way, it saves time and resources and reduces the cost of production.

### BRIEF DESCRIPTION OF THE DRAWINGS

FIG. 1 is a perspective view of the battery connector;

FIG. 2 is a perspective view of a housing of the battery connector;

FIG. 3 is a perspective view of an electric terminal of the battery connector;

FIG. 4 is a cross-sectional view of the housing of the battery connector; and

FIG. 5 is a cross-sectional view of the assembly of the battery connector.

### DETAILED DESCRIPTION OF THE PREFERRED EMBODIMENT

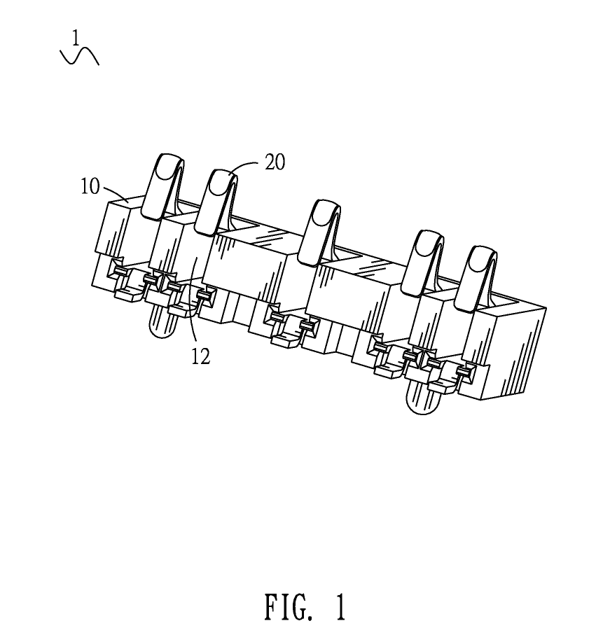

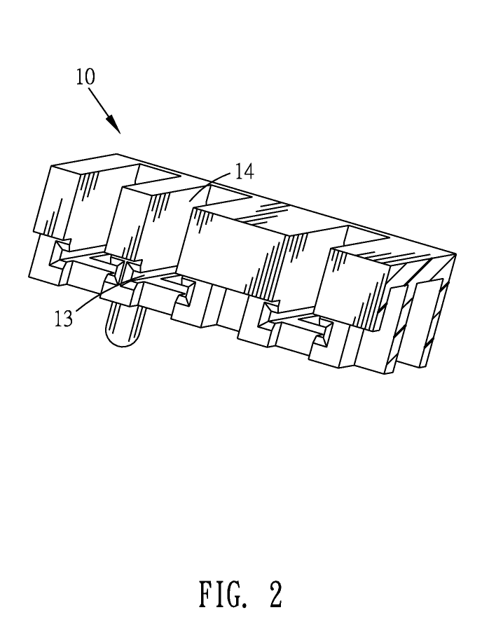

With reference to FIG. 1 and FIG. 2, the battery connector 1 includes a housing 10 having terminal recesses 12 and a plurality of electric terminals 20. The terminal recess 12 has a receiving cavity 14 extending from the top of the housing 10 to the bottom of the housing 10. An inlay recess 13 defined in the bottom of the housing 10 communicates with the receiving cavity 14. The inlay recess 13 is wider than the receiving cavity 14 for receiving the base portion 21 of the electric terminal 20.

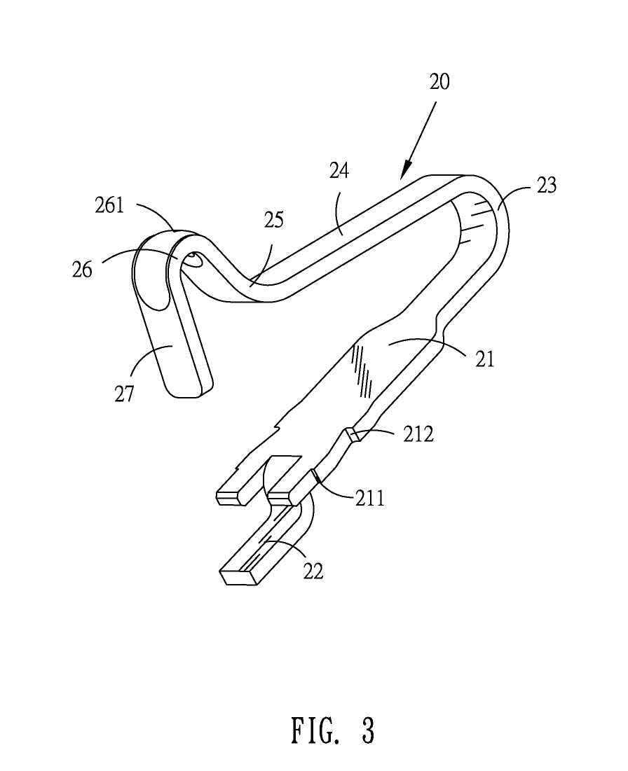

Referring to FIG. 3, the electric terminal 20 has a base portion 21. A pair of first barbs 211 and a pair of second barbs 212 are arranged on the two edges of the base portion 21. The base portion 21 of the electric terminal 20 bends downward and extends forward to form a soldering portion 22 in the middle of the end of base portion 21. As a result, the end of base portion 21 will be U-shaped. The other end of the base portion 21 extends forward and bends upward to form a first arc 23. The first arc 23 slopes towards the top of the receiving cavity 14 to form a resilient arm 24 above the base portion 21 for linking the first arc 23 and a second arc 25. The other end of the second arc 25 opposite to the resilient arm 24 bends upward to form a contacting portion 26. The contacting portion 26 extends downward to form a braking portion 27 above the soldering portion 22. A mating surface 261 is covered on the top of the contacting portion 26 for connecting a battery (not show).

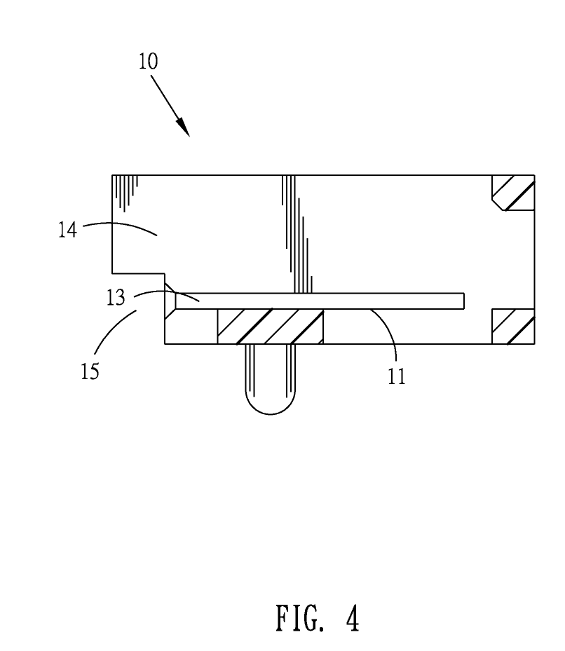

Referring to FIG. 2 and FIG. 4, the housing 10 has an opening 15 at the front of the inlay recess 13. The opening 15 at the bottom of the housing 10 exposes the soldering portion 22 of the electric terminal 20.

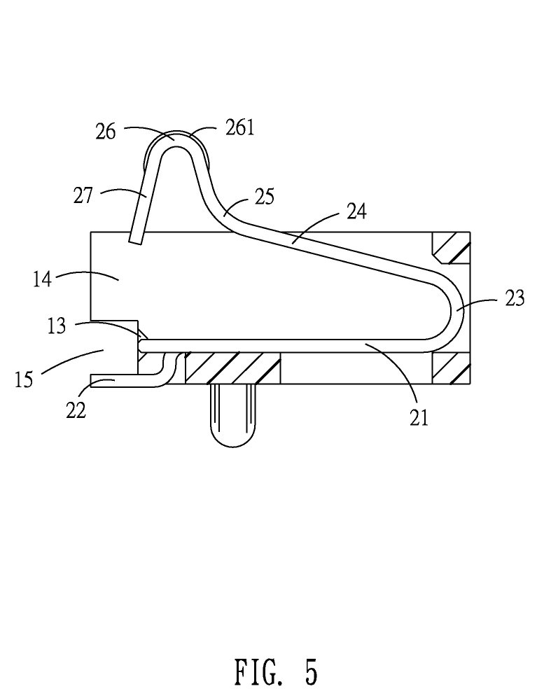

Referring to FIG. 5, in assembly, the base portion 21 of the electric terminal 20 is fixed in the inlay recess 13 by the first barb 211 and the second barb 212 contacting with the sidewall 11 of the housing 10. The first arc 23, the resilient arm 24, the second arc 25 and the braking portion 27 are received in the receiving cavity 14. The top of the braking portion 27 is situated at the space above the soldering portion 22. The contacting portion 26 extends out of the receiving cavity 14 for contacting with the battery (not show). The soldering portion 22 exposes at the opening 15 of the housing 10. A repairman can replenish solder to the soldering portion 22 by the opening 15 if the machine (not show) omits soldering the soldering portion 22 of the battery connector 1 during excessive production.

What is claimed is:

1. A battery connector comprising:
a housing having a terminal recess, the terminal recess having an inlay recess in the bottom of the terminal recess and a receiving cavity extending from the top of the terminal recess to the inlay recess, an opening being dug at the end of the inlay recess; and
a plurality of electric terminals having a base portion, a contacting portion and a soldering portion; the base portion of the electric terminal bending downward and then extending forward to form a soldering portion in the middle of the end of base portion, the other end of the base portion extending forward and bending upward to form a first arc, the first arc sloping towards the top of the receiving cavity to form a resilient arm above the base portion for linking the first arc and a second arc, the other end of the second arc opposite to the resilient arm bending upward to form a contacting portion, the contacting portion extending downward to form a braking portion above the soldering portion.

2. The battery connector as claimed in claim 1, wherein two pairs of barbs are arranged on edges of the base portion.

3. The battery connector as claimed in claim 1, wherein a mating surface is covered on the top of the contacting portion.
